(19) United States
(12) Patent Application Publication
(10) Pub. No.: US 2006/0005210 A1
(43) Pub. Date: Jan. 5, 2006

(54) Two-way disc clamping mechanisms and multiple disc read and write systems

(75) Inventors: Ching-Mei Chiang, Taipei County (TW); Thomas Lee, Hsinchu City (TW); Show-Hsiung Lin, Taipei County (TW); Yu-Chi Lin, Taipei County (TW); Guang-Chyan Fang, Hsinchu City (TW); Pei-Fang Liang, Hsinchu City (TW); Arthur Hsueh, Hsinchu City (TW)

Correspondence Address: BIRCH STEWART KOLASCH & BIRCH, PO BOX 747, FALLS CHURCH, VA, 22040-0747, US

(73) Assignee: YUNG-TANG SCIENCE & TECHNOLOGY INDUSTRY CO., LTD

(21) Appl. No.: 11/155,581

(22) Filed: Jun. 20, 2005

(30) Foreign Application Priority Data
Jun. 30, 2004 (TW) 93119479

(51) Int. Cl. G11B 17/03

(52) U.S. Cl. 720/600

(57) ABSTRACT

Multiple disc read and write systems and two-way disc clamping mechanisms thereof are provided. A two-way disc clamping mechanism includes a frame, two parallel support components, two parallel clamp components, an L-shaped drive component, and a spring. Space between the two parallel clamp components is a clamping space. The L-shaped drive component comprises a contact end and a driving end. The contact end contacts one of the two parallel clamp components. When the driving end receives an external force, the contact end generates a pushing force on one of the corresponding parallel clamp components by leverage. The clamping space is modified by adjusting the external force to clamp or release a disc. The two-way disc clamping mechanism allows the disc to enter the clamping space from a left side or a right side thereof.

### BACKGROUND

The invention relates to two-way disc clamping mechanisms and multiple disc read and write systems.

Due to technology development and higher user requirements, disc drives for entertainment, such as home or automobile video disc drives, have developed from traditional single disc drives to multiple disc systems capable of storing 4, 6, or more discs.

As video resolution or audio quality increases, a greater number of discs are required for storage of movies, music, and the like. Thus, disc cabinets capable of storing several hundred discs have been developed. Typically, discs are placed vertically to simplify design. Vertical disc cabinets however occupy a large amount of space. Alternatively, discs are placed horizontally, thus reducing the required space but complicating disc clamper design.

Disc cabinets require disc changers to access and move discs between storage locations and read and write locations. Disc changers comprise disc clampers, typically with a semicircular shape, for clamping discs by their edges. Despite different disc thicknesses, the size of a conventional semicircular disc damper is typically about the size of a disc, thus consuming excessive space.

### SUMMARY

A two-way disc clamping mechanism is provided. An exemplary embodiment of a two-way disc clamping mechanism comprises a frame, two parallel support components, two parallel clamp components, an L-shaped drive component, and a spring. The two parallel support components are rotatably hinged on the frame. Both ends of each clamp component are rotatably hinged on both parallel support components respectively. A clamping space exists between the two parallel clamp components. The L-shaped drive component is rotatably hinged on the frame. The L-shaped drive component comprises a contact end and a driving end. The contact end contacts one of the parallel clamp components. When the driving end receives an external force, the contact end generates a pushing force on a corresponding parallel clamp component by leverage. The spring is connected between the frame and one of the parallel clamp components. The spring exerts a preset first resilient force on one of the corresponding parallel clamp components. The clamping space is modified by adjusting the external force to clamp or release a disc. The two-way disc clamping mechanism allows the disc to enter the clamping space from a left side or a right side thereof.

A disc changing mechanism is also provided. An exemplary embodiment of a disc changing mechanism, for accessing a disc placed in a disc case, comprises a support stand, a bearing platform, a two-way disc clamping mechanism as described above, and a disc ejection mechanism. The bearing platform is upward and downward movably placed on the support stand. The two-way disc clamping mechanism is leftward and rightward movable and placed on the bearing platform by the frame thereof for clamping or releasing the disc at a first operating location corresponding to the disc case. The disc ejection mechanism comprises two disc ejection levers respectively fixed on a left side and a right side of the bearing platform for pushing the disc from the inside of the disc case to the clamping space of the two-way disc clamping mechanism. When the disc changing mechanism is in retrieval mode, the two-way disc clamping mechanism moves to the corresponding first operating location, the corresponding disc ejection lever pushes the disc from the inside of the disc case to the clamping space of the two-way disc clamping mechanism, and the two-way disc clamping mechanism clamps the disc removing it from the disc case. When the disc changing mechanism is in placement mode, the two-way disc clamping mechanism moves to the corresponding first operating location, moves the clamped disc to the inside of the disc case, and releases the disc.

A multiple disc read and write system is also provided. An exemplary embodiment of a multiple disc read and write system, capable of disc changing, comprises a base, two disc cabinets, a read and write mechanism, and a disc changing mechanism as described above. The two disc cabinets are respectively fixed on a left end and a right end of the base. Each disc cabinet comprises a plurality of disc cases stacked vertically for accommodating a plurality of discs horizontally. The read and write mechanism is fixed on the base for reading and writing data on the discs. The disc changing mechanism is fixed on the base by the support stand thereof. The two-way disc clamping mechanism moves to a plurality of first operating locations corresponding to the disc cases to clamp or release the discs. The two-way disc clamping mechanism moves to a second operating location corresponding to the read and write mechanism to clamp or release the discs.

### DESCRIPTION OF THE DRAWINGS

Two-way disc clamping mechanisms and multiple disc read and write systems can be more fully understood by reading the subsequent detailed description and examples with references made to the accompanying drawings, wherein:

FIG. 1 is a 3-D diagram of an embodiment of a two-way disc clamping mechanism.

FIG. 2 is a cutaway view of the two-way disc clamping mechanism in FIG. 1 from the left side.

FIG. 3 is a 3-D diagram of an embodiment of a disc changing mechanism.

FIG. 4 is a schematic diagram showing the disc changing mechanism in FIG. 3 accessing a disc in a disc case.

FIG. 5 is a 3-D diagram of a return spring.

FIG. 6 is a schematic diagram showing a disc ejection mechanism pushing a disc from inside a disc case to a clamping space of the two-way disc clamping mechanism in FIG. 1.

FIG. 7 is a schematic diagram of an embodiment of a multiple disc read and write system.

FIG. 8 is a schematic diagram showing a chassis removed from a housing and a base rotated with an appropriate angle.

### DETAILED DESCRIPTION

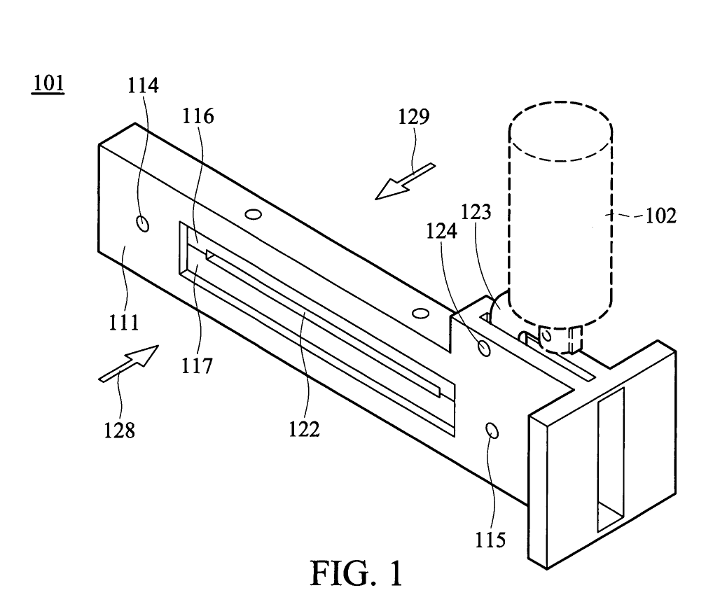

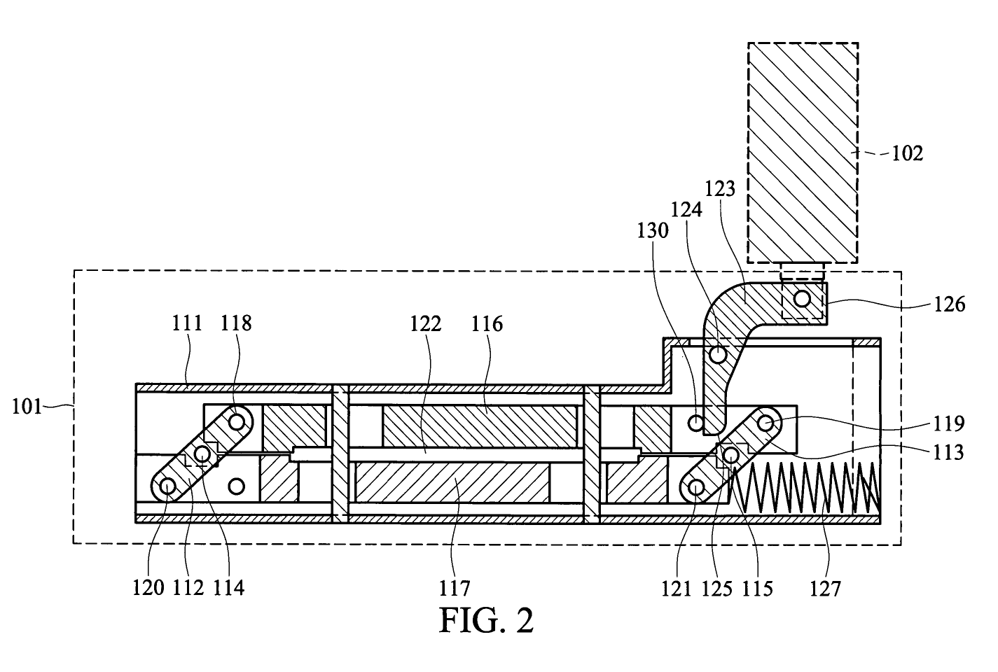

FIG. 1 is a 3-D diagram of an embodiment of a two-way disc clamping mechanism 101. FIG. 2 is a cutaway view of the two-way disc clamping mechanism 101 in FIG. 1 from the left side, as indicated by the arrow 128. The two-way disc clamping mechanism 101 comprises a frame 111, parallel first and second support components 112 and 113, parallel first and second clamp components 116 and 117, an L-shaped drive component 123, and a spring 127. The first support component 112 is rotatably connected to a hinge 114 of the frame 111, and the second support component 113 is rotatably connected to a hinge 115 of the frame 111. Two ends of the first clamp component 116 are rotatably connected respectively to a hinge 118 of the first support component 112 and a hinge 119 of the second support component 113. Similarly, two ends of the second clamp component 117 are rotatably connected respectively to a hinge 120 of the first support component 112 and a hinge 121 of the second support component 113. The first support component 112, the second support component 113, the first clamp component 116, and the second clamp component 117 comprise a rectangular four-bar linkage. Space between the first and second clamp components 116 and 117 comprises a clamping space 122. The spring 127 is connected between the frame 111 and the second clamp component 117. Because an appropriate preset force is exerted to the spring 127, the spring 127 generates a first resilient force on the second clamp component 117. As shown in FIG. 2, the first resilient force pushes the second clamp component 117 forward, so that the space between the first and second clamp components 116 and 117 is reduced reducing the clamping space 122 to its minimum. The two-way disc clamping mechanism 101 is thus closed and prevents disc insertion. The L-shaped drive component 123 is rotatably connected to a hinge 124 of the frame 111. The L-shaped drive component 123 comprises a contact end 125 and a driving end 126. The contact end 125 contacts a protrusion 130 of the first clamp component 116. The driving end 126 is connected with a power source 102, such as a motor or an electromagnetic valve, to receive an external force provided thereby. The external force pushes the driving end 126 downwards, so the contact end 125 generates a pushing force on the protrusion 130 by leverage. Thus, the first clamp component 116 is pushed forward, increasing the distance between the first and second clamp components 116 and 117 enlarging the clamping space 122. The two-way disc clamping mechanism 101 is thus open. The two-way disc clamping mechanism 101 clamps the disc by the first and second clamp components 116 and 117 to tightly contact an upper surface and a lower surface of the disc respectively. The two-way disc clamping mechanism 101 clamps the disc along a vertical direction. Thus, the disc can be inserted when a height of the clamping space 122 is increased to larger than a thickness of the disc. Moreover, a lower surface of the first clamp component 116 and an upper surface of the second clamp component 117 are both covered with a smooth elastic material to protect the disc surface when clamped. The clamping space 122 is adjusted by varying the external force provided by the power source 102, such as a motor or an electromagnetic valve, to clamp or release the disc. The distance between the first and second clamp components 116 and 117 increases enlarging the clamping space 122 as the external force increases. Thus, the two-way disc clamping mechanism 101 is opened. Conversely, the space between the first and second clamp components 116 and 117 is reduced reducing the clamping space 122 as the external force decreases, so the two-way disc clamping mechanism 101 is closed. Additionally, the two-way disc clamping mechanism 101 allows the disc to enter the clamping space 122 from a left side, as indicated by the arrow 128, or a right side, as indicated by the arrow 129.

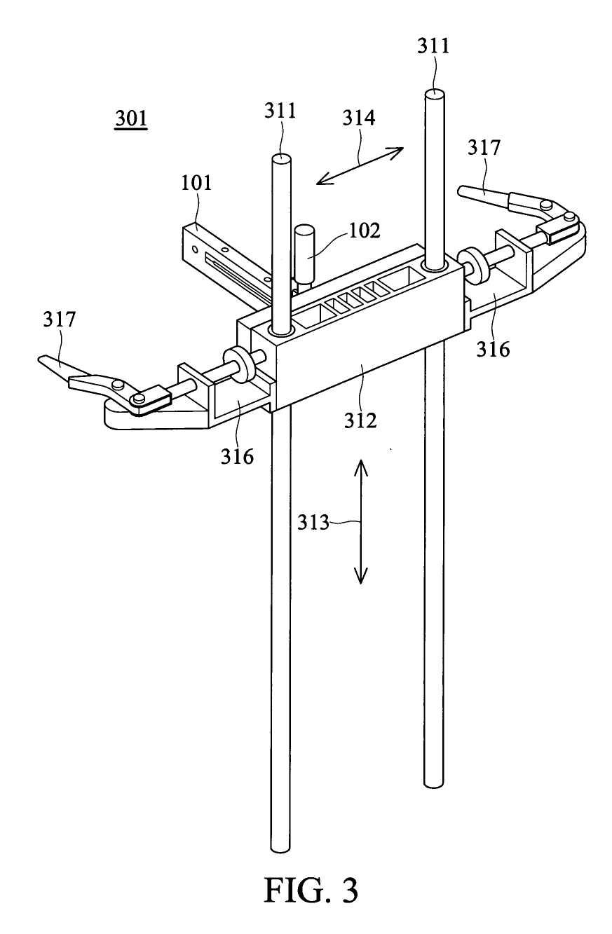

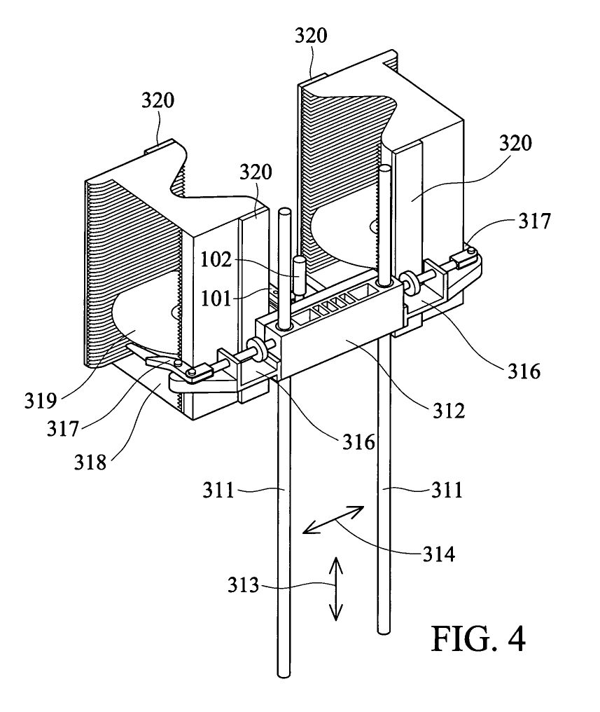

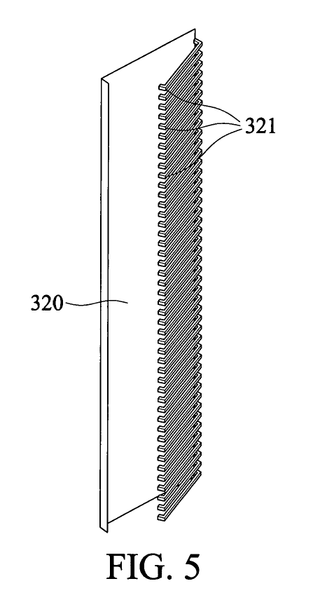

FIG. 3 is a 3-D diagram of an embodiment of a disc changing mechanism 301. FIG. 4 is a schematic diagram showing the disc changing mechanism 301 in FIG. 3 accessing a disc 319 in a disc case 318. FIG. 5 is a 3-D diagram of a return spring 320. The disc changing mechanism 301 comprises a support stand 311, a bearing platform 312, the two-way disc clamping mechanism 101, and a disc ejection mechanism 316. The bearing platform 312 is placed on the support stand 311 and is able to move freely along an upward-downward direction 313. The two-way disc clamping mechanism 101 is placed on the bearing platform 312 by the frame 111 thereof and can move freely along a leftward-rightward direction 314. The disc ejection mechanism 316 comprises two disc ejection levers 317 respectively fixed on a left side and a right side of the bearing platform 312. Each side of the disc case 318 comprises a return spring 320, which is a two-way flat spring, as shown in FIG. 5. Because an appropriate preset force is exerted to the return spring 320, the return spring 320 generates a second resilient force on the disc 319.

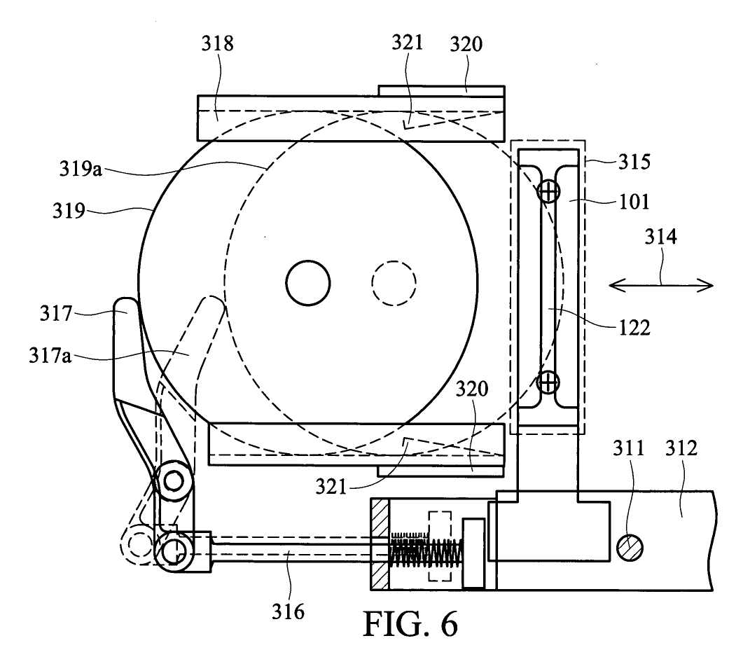

FIG. 6 is a schematic diagram showing a disc ejection mechanism 316 pushing the disc 319 from inside of the disc case 318 to the clamping space 122 of the two-way disc clamping mechanism 101 in FIG. 1. When the disc changing mechanism 301 is in retrieval mode, a driving device (not shown) adjusts the location of the bearing platform 312 vertically and the location of the two-way disc clamping mechanism 101 horizontally, so the two-way disc clamping mechanism 101 is moved to a first operating location 315 corresponding to the disc case 318. The power source 102, such as a motor or an electromagnetic valve, exerts external force on the driving end 126 to open the two-way disc clamping mechanism 101. The disc ejection lever 317 is then driven by a driving device (not shown) to push the disc 319 from the disc case 318 to a first intermediate location (not shown), i.e. the disc 319 is pushed to a pinnacle 321 of the return spring 320. The second resilient force generated by the return spring 320 further pushes the disc 319 to the clamping space 122 of the two-way disc clamping mechanism 101. Finally, the power source 102, such as a motor or an electromagnetic valve, stops generating the external force on the driving end 126 to gradually close the two-way disc clamping mechanism 101. The two-way disc clamping mechanism 101 thus clamps the disc 319 removing it from the disc case 318. The dashed lines in FIG. 6 indicate locations of the disc ejection lever 317a and the disc 319a after the disc ejection lever 317 pushes the disc 319 from inside the disc case 318 to the clamping space 122 of the two-way disc clamping mechanism 101.

When the disc changing mechanism 301 is in placement mode, a driving device (not shown) adjusts the location of the bearing platform 312 vertically and the location of the two-way disc clamping mechanism 101 horizontally, so the two-way disc clamping mechanism 101 is moved to a first operating location 315 corresponding to the disc case 318. The two-way disc clamping mechanism 101 moves the clamped disc 319 to a second intermediate location (not shown), i.e. the disc 319 is pushed to the pinnacle 321 of the return spring 320, and then releases the disc 319. The second resilient force generated by the return spring 320 further pushes the disc 319 into the disc case 318. Thus, the disc 319 can be moved between any two disc cases by the disc changing mechanism 301.

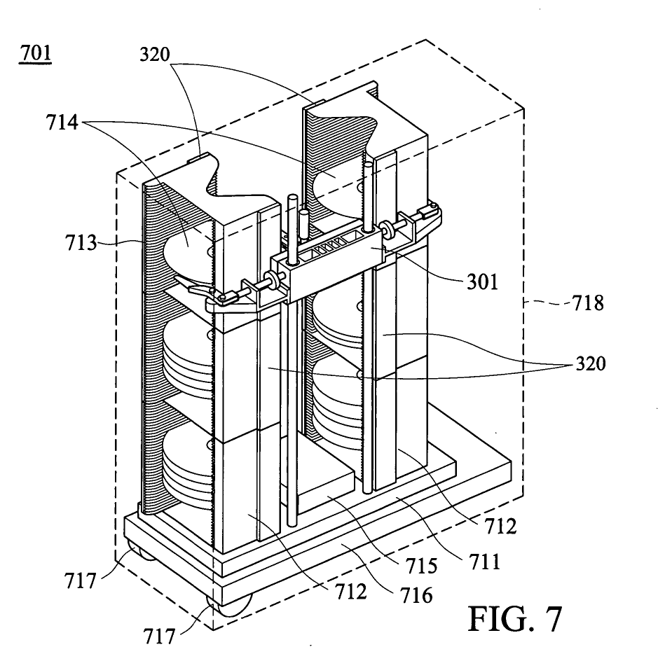

FIG. 7 is a schematic diagram of an embodiment of a multiple disc read and write system 701. The multiple disc read and write system 701 is capable of changing discs and comprises a housing 718, a chassis 716, a base 711, two disc cabinets 712, a read and write mechanism 715, and the disc changing mechanism 301. The housing 718 covers and protects the entire system. The chassis 716 is rotatably fixed to the base 711 and comprises roll wheels 717 for bearing the chassis 716. The two disc cabinets 712 are respectively fixed on a left end and a right end of the base 711. Each disc cabinet 712 comprises three disc cases 713 stacked vertically for accommodating discs 714. Each disc case 713 can accommodate 30 to 50 discs 714. Each disc case 713 is designed based on a module capable of continuous vertical stacking. Each disc case 713 comprises V-shaped grooves for inserting the discs 714. The discs 714 slide freely in the V-shaped grooves to a specific location where the discs 714 are securely held thereby. The V-shaped grooves also facilitate disc access by the two-way disc clamping mechanism 101. Moreover, each side of the disc case 713 comprises the return spring 320, which is a two-way flat spring, as shown in FIG. 5. Because the appropriate preset force is exerted to the return spring 320, the return spring 320 generates the second resilient force on the discs 714. The read and write mechanism 715 is fixed on the base 711 for reading and writing data on the discs 714. The disc changing mechanism 301 is fixed on the base 711 by the support stand 311 thereof. The discs 714 can be moved between any two disc cases 713 by the disc changing mechanism 301, as described above. Additionally, when the system is in read and write mode, the two-way disc clamping mechanism 101 moves to a second operating location (not shown) corresponding to the read and write mechanism 715 to clamp or release the discs 714. Therefore, the read and write mechanism 715 can read or write data on the discs 714.

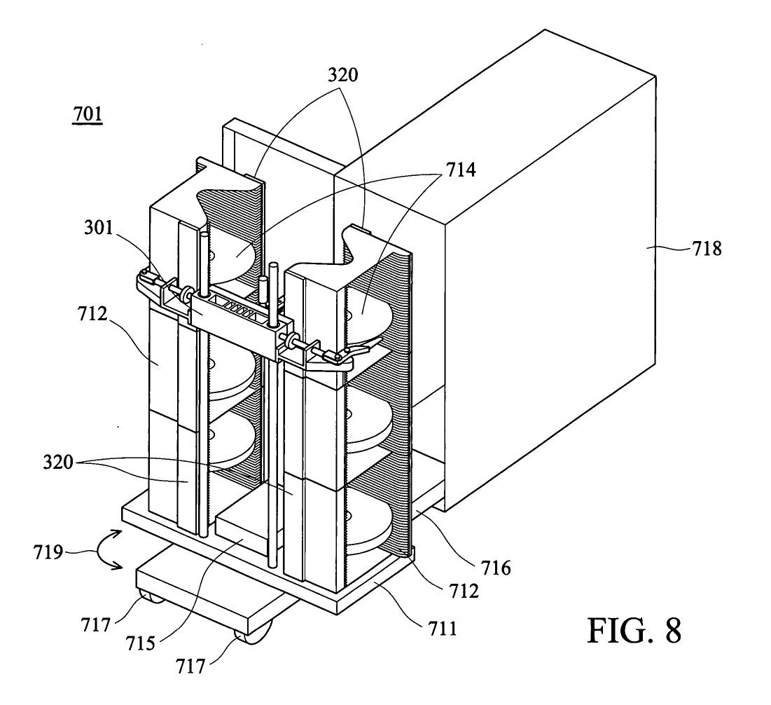

FIG. 8 is a schematic diagram showing the chassis 716 removed out of the housing 718 and the base 711 rotated to an appropriate angle 719. When a large amount of disc access is desired, the chassis 716 with the entire system thereon is removed from the housing 718, and the base 711 is rotated by the appropriate angle 719 to facilitate disc access by hand.

In some embodiments of the multiple disc read and write system, the two-way disc clamping mechanism utilizes a rectangular four-bar linkage to clamp the rim of the disc to stably move the disc to the read and write mechanism or between two disc cases. Compared with the conventional semicircular disc clamper, the two-way disc clamping mechanism is more compact and allows two-way insertion of the disc, thus reducing space required by the entire system. Additionally, each side of the disc case comprises a return spring, which is a two-way flat spring. In retrieval or placement mode, the second resilient force of the return spring pushes the disc to the desired location if the disc has previously been pushed to the pinnacle of the return spring, thus potentially reducing disc motion and motor operation.

While the invention has been described by way of example and in terms of several embodiments, it is to be understood that the invention is not limited thereto. To the contrary, it is intended to cover various modifications and similar arrangements (as would be apparent to those skilled in the art) . Therefore, the scope of the appended claims should be accorded the broadest interpretation so as to encompass all such modifications and similar arrangements.

What is claimed is:

1. A two-way disc clamping mechanism, comprising:
a frame;
two parallel support components rotatably fixed to the frame;
two parallel clamp components, wherein two ends of each clamp component are rotatably fixed respectively to the two parallel support components, and the space between the two parallel clamp components is a clamping space;
an L-shaped drive component rotatably fixed to the frame and comprising a contact end and a driving end, wherein the contact end contacts one of the two parallel clamp components, and when the driving end receives an external force, the contact end generates a pushing force on one of the corresponding parallel clamp components by leverage; and
a spring connected between the frame and one of the two parallel clamp components and exerting a preset first resilient force on the corresponding one of the two parallel clamp components;
wherein the clamping space is adjusted by varying the external force to clamp or release a disc, and the two-way disc clamping mechanism allows the disc to enter the clamping space from a left side or a right side thereof.

2. The two-way disc clamping mechanism as claimed in claim 1, wherein the disc is clamped by the two parallel clamp components securely contacting an upper surface and a lower surface of the disc respectively.

3. The two-way disc clamping mechanism as claimed in claim 1, wherein the one of the parallel clamp components corresponding to the contact end comprises a protrusion, the contact end contacts the protrusion, and when the driving end receives the external force, the contact end generates the pushing force on the protrusion by leverage.

4. The two-way disc clamping mechanism as claimed in claim 1, wherein the distance between the two parallel clamp components is increased enlarging the clamping space as the external force increases, and the space between the two parallel clamp components is reduced reducing the clamping space as the external force decreases.

5. The two-way disc clamping mechanism as claimed in claim 1, wherein the driving end is connected with a motor or an electromagnetic valve to receive the external force provided thereby.

6. A disc changing mechanism for accessing a disc placed in a disc case, comprising:
a support stand;
a bearing platform movable upward and downward and placed on the support stand;
a two-way disc clamping mechanism as claimed in claim 1 movable leftward and rightward and placed on the bearing platform by the frame thereof for clamping or releasing the disc at a first operating location corresponding to the disc case; and
a disc ejection mechanism comprising two disc ejection levers respectively fixed on a left side and a right side of the bearing platform for pushing the disc from inside the disc case to the clamping space of the two-way disc clamping mechanism;
wherein when the disc changing mechanism is in retrieval mode, the two-way disc clamping mechanism moves to the corresponding first operating location, the corresponding disc ejection lever pushes the disc from inside the disc case to the clamping space of the two-way disc clamping mechanism, and the two-way disc clamping mechanism clamps the disc to remove it from the disc case, and when in placement mode, the two-way disc clamping mechanism moves to the corresponding first operating location, moves the clamped disc to inside the disc case, and releases the disc.

7. The disc changing mechanism as claimed in claim 6, wherein the disc case comprises a return spring, which is a two-way flat spring, exerting a preset second resilient force on the disc, when the disc changing mechanism is in retrieval mode, the two-way disc clamping mechanism moves to the corresponding first operating location, the corresponding disc ejection lever pushes the disc from inside of the disc case to a first intermediate location, the preset second resilient force further pushes the disc to the clamping space of the two-way disc clamping mechanism, and the two-way disc clamping mechanism clamps the disc to remove it from the disc case, and when in placement mode, the two-way disc clamping mechanism moves to the corresponding first operating location, moves the clamped disc to a second intermediate location, and releases the disc, and the preset second resilient force further pushes the disc into the disc case.

8. A multiple disc read and write system capable of changing discs, comprising:
a base;
two disc cabinets respectively fixed on a left end and a right end of the base, wherein each disc cabinet comprises a plurality of disc cases stacked vertically for accommodating a plurality of discs;
a read and write mechanism fixed on the base for reading and writing data on the discs; and
a disc changing mechanism as claimed in claim 6 fixed on the base by the support stand thereof, wherein the two-way disc clamping mechanism moves to a plurality of first operating locations corresponding to the disc cases to clamp or release the discs, and the two-way disc clamping mechanism moves to a second operating location corresponding to the read and write mechanism to clamp or release the discs.

9. The multiple disc read and write system as claimed in claim 8 further comprising a chassis rotatably fixed to the base and comprising a plurality of wheels for bearing the chassis.

10. The multiple disc read and write system as claimed in claim 9 further comprising a housing for covering the entire system.

11. The multiple disc read and write system as claimed in claim 10, wherein when the chassis is removed from the housing, the base is rotated by an appropriate angle for disc access by hand.

12. The multiple disc read and write system as claimed in claim 8, wherein each disc case comprises a return spring, which is a two-way flat spring, exerting a preset second resilient force on the corresponding disc, when the disc changing mechanism is in retrieval mode, the two-way disc clamping mechanism moves to the corresponding first operating location, the corresponding disc ejection lever pushes the corresponding disc from inside of the disc case to a first intermediate location, the preset second resilient force further pushes the corresponding disc to the clamping space of the two-way disc clamping mechanism, and the two-way disc clamping mechanism clamps the corresponding disc to remove it from the disc case, and when in placement mode, the two-way disc clamping mechanism moves to the corresponding first operating location, moves the clamped disc to a second intermediate location, and releases the corresponding disc, and the preset second resilient force further pushes the corresponding disc into the disc case.
